(19) United States
(12) Patent Application Publication
(10) Pub. No.: US 2007/0266358 A1
(43) Pub. Date: Nov. 15, 2007

(54) Yield calculation method

(76) Inventor: Yoko Tohyama, Kyoto (JP)

Correspondence Address: MCDERMOTT WILL & EMERY LLP, 600 13TH STREET, NW, WASHINGTON, DC, 20005-3096, US

(21) Appl. No.: 11/702,642

(22) Filed: Feb. 6, 2007

(30) Foreign Application Priority Data
May 9, 2006 (JP) 2006-130365

(51) Int. Cl. G06F 17/50

(52) U.S. Cl. 716/8

(57) ABSTRACT

A yield of a device including a plurality of memory circuits is calculated. In the calculation, in the case where at least two or more memory circuits out of the plural memory circuits share a fuse used for redundancy repair, the two or more memory circuits sharing the fuse are replaced with one memory circuit having a capacity equal to the total capacity of the two or more memory circuits for calculating the yield of the device.

### BACKGROUND OF THE INVENTION

The present invention relates to yield calculation for a device including a fuse.

In the fabrication of semiconductor devices such as LSIs (large scale integrations), the cost of the semiconductor devices can be lowered by obtaining a large number of good LSIs from one semiconductor substrate (semiconductor wafer), namely, by improving the yield.

As a method for improving the yield, what is called redundancy repair in which a cell having a defect is replaced with another cell is generally widely employed for a memory cell such as an SRAM (static random access memory). Furthermore, in the redundancy repair, a method of electrically cutting a given portion (what is called an electric fuse) of a circuit is recently employed instead of a conventional method of cutting a metal fuse by laser trimming.

The known factors for lowering the yield are, for example, defects such as particles causing short or open of interconnects or via formation failure in respective steps (particularly, a wiring step) of the LSI fabrication process. The density of defects such as particles can be estimated on the basis of, for example, dust distribution information of a cleaning room where the LSIs are fabricated. As the chip size of the LSIs is larger, the number of defects such as particles caused in one LSI chip is increased, and hence, the yield is lowered.

It is significant to calculate the yield of LSIs at the design stage for estimating the fabrication cost of the LSIs. Therefore, a yield model such as a Poisson model represented by the following Formula 1 or a negative binominal model represented by the following Formula 2 is used:

Y=exp(−Ac·D0) Formula 1

Y=(1+Ac·D0/α)^{(-α)} Formula 2

wherein Y is a yield, Ac is a critical area (cm²), D0 is a defect density (/cm²) and α is a coefficient corresponding to a clustering degree.

With respect to a yield of open/short of interconnects, a method using, for calculating the yield, a defect distribution curve and a critical area where a defect actually causes a failure has been proposed (see Non-patent document 1 below). A critical area is an index for quantitatively indicating the degree that a defect causes short or disconnection derived from open in the respective steps of the LSI fabrication process, and is equal to a sum of areas in which a defect actually causes a failure in a chip.

Methods for calculating such a critical area are roughly divided into two methods, that is, a method using graphic data processing (see, for example, Patent document 1 and Non-patent document 2 below) and a method using Monte Carlo simulation (see, for example, Patent documents 2 and 3 below).

In the method using graphic data processing, interconnect patterns are made thicker correspondingly to a radius of a particle, so as to define a portion where adjacent interconnects overlap as a critical area.

In the method using Monte Carlo simulation, with particles having random diameters generated, adjacent interconnects connected through such a particle are regarded as short, and a large number of such virtual particles are generated, so as to calculate a ratio of particles causing short among all the particles. A value thus calculated is approximate to a value obtained by normalizing a critical area by a chip area.

Also, a method for calculating a redundancy repair yield of an SRAM or the like based on a result of critical area analysis has been disclosed (see Non-patent document 3 below).

The yield of a semiconductor product including a memory equipped with a redundancy repair circuit can be accurately predicted by any of the aforementioned yield prediction methods.

Patent document 1: Japanese Laid-Open Patent Publication No. 2002-163323

Patent document 2: Japanese Laid-Open Patent Publication No. 2002-156418

Patent document 3: Japanese Laid-Open Patent Publication No. 2001-344301

Non-patent document 1: C. H. Stapper, Modeling of Integrated Circuit Defect Sensitivities, IBM J. Res. Develop., U.S.A., November 1983, Vol. 27, pp. 549-557

Non-patent document 2: A. G. Allen et al., Efficient Critical Area Estimation for Arbitrary Defect Shapes, IEEE International Symposium on Defect and Fault Tolerance in VLSI Systems, October 1997, pp. 20-28

Non-patent document 3: Jitendra Khare, Accurate Estimation of Defect-Related Yield Loss in Reconfigurable VLSI Circuits, IEEE Journal of Solid-state Circuits, U.S.A., February 1993, Vol. 28, pp. 146-156

### SUMMARY OF THE INVENTION

In order to effectively use an electric fuse while minimizing the increase of a chip area caused by mounting the electric fuse for the redundancy repair, a technique designated as electric fuse share in which a plurality of SRAMs are connected to one electric fuse used for performing the redundancy repair on all the plural SRAMs has been started to employ.

However, the above-described conventional yield calculation method for a semiconductor product including a memory equipped with a redundancy repair circuit cannot be employed for yield calculation of a product in which one redundancy electric fuse is shared by a plurality of SRAMs.

Specifically, for determining whether or not the fuse share is employed and what scale the fuse share is employed in an actual product, it is necessary to accurately determine a fuse share condition for maximizing the number of good chips possibly obtained from one wafer by calculating product yields and chip areas corresponding to respective fuse share conditions before starting layout design of the product, for example, before starting the design of an actual product or at a stage of examination of profitability. In order to perform the critical area analysis necessary for the yield prediction, the design data of the product is necessary. However, the layout data is not completed as described above at the stage where it is necessary to determine whether or not the fuse share is employed or what scale the fuse share is employed, and therefore, the critical area analysis, the yield prediction through the critical area analysis and the determination of an optimum fuse share condition cannot be carried out.

The present invention was devised in consideration of the above-described conventional problem, and a first object of the invention is predicting a yield appropriately when a fuse used for redundancy repair of a memory cell is shared by a plurality of memory circuits. Furthermore, a second object of the invention is, even in the case where a fuse share condition is arbitrarily set before starting the design of an actual product, predicting chip sizes and yields corresponding to respective conditions and determining a fuse share condition for maximizing the number of good chips obtained from one wafer.

In order to achieve the first object, in the first yield calculation method of this invention, layout data of an actual product is used so that a critical area of a memory cell array portion and a critical area of a peripheral circuit portion are separately dealt with in a memory circuit to be subjected to redundancy repair, and in accordance with a fuse share condition, all memory circuits sharing one fuse are regarded as a single memory circuit for calculating a yield attained after the redundancy repair.

Specifically, in the first yield calculation method, in the case where, for example, four SRAMs, that is, a memory circuit 1, a memory circuit 2, a memory circuit 3 and a memory circuit 4, share a redundancy repair electric fuse as shown in FIG. 1, the critical area of the memory circuit 1 is calculated correspondingly to a memory cell array portion 1a and a peripheral circuit portion 1b, the critical area of the memory circuit 2 is calculated correspondingly to a memory cell array portion 2a and a peripheral circuit portion 2b, the critical area of the memory circuit 3 is calculated correspondingly to a memory cell array portion 3a and a peripheral circuit portion 3b, and the critical area of the memory circuit 4 is calculated correspondingly to a memory cell array portion 4a and a peripheral circuit portion 4b. At this point, the critical areas are calculated by, for example, the method described in Non-patent document 2. As a characteristic of the first yield calculation method of this invention, in the case where, for example, the sum of the critical areas of the four SRAMs is calculated correspondingly to the memory cell array portions and the peripheral circuit portions, the sum of the critical areas of the memory cell array portion 1a, the memory cell array portion 2a, the memory cell array portion 3a and the memory cell array portion 4a is regarded as a critical area of a virtual memory cell array portion 5a, and the sum of the critical areas of the peripheral circuit portion 1b, the peripheral circuit portion 2b, the peripheral circuit portion 3b and the peripheral circuit portion 4b is regarded as a critical area of a virtual peripheral circuit portion 5b. Thus, the four SRAMs (i.e., the memory circuits 1 through 4) are replaced with a fifth SRAM (i.e., a memory circuit 5) having a capacity equal to the total capacity of the four SRAMs.

In a conventional method for calculating a yield attained after the redundancy repair, each of the memory circuits 1 through 4 is provided with, for example, one redundancy repair circuit, so as to calculate a yield attained after the redundancy repair by a method, for example, described in Non-patent document 3 on the assumption that each of the memory circuits 1 through 4 can be independently repaired. On the contrary, in the first yield calculation method of this invention, the fifth SRAM (the memory circuit 5) having the capacity equal to the total capacity of the four SRAMs (the memory circuits 1 through 4) and including one redundancy repair circuit is assumed, so as to calculate a yield attained after the redundancy repair by using the critical areas of the memory cell array portion 5a and the peripheral circuit portion 5b. In other words, according to the first yield calculation method of this invention, a yield can be predicted appropriately in the case where a fuse used for the redundancy repair of a memory cell is shared by a plurality of memory circuits.

In order to achieve the second object, the second yield calculation method of this invention has substantially the same characteristic as the first yield calculation method of this invention except that a critical area of an ultimately completed product is obtained through calculation without using layout data of an actual product, namely, before starting design of the layout of an actual product.

Specifically, in the second yield calculation method of this invention, average values, medians or the like of critical areas of respective units of the redundancy repair are previously calculated separately with respect to a memory cell array portion and a peripheral circuit portion by using, for example, layout data of an existing SRAM of another product type. In the calculation of a critical area value of a memory cell array portion (hereinafter referred to as a memory cell portion), the capacity of the memory cell portion and a critical area value per unit capacity of the existing product type or the like are preferably used, and in the calculation of a critical area value of a peripheral circuit portion, the area of the peripheral circuit portion and a critical area value per unit area of the existing product type or the like are preferably used. At this point, the critical area values per unit capacity and per unit area of the existing product type or the like are previously stored in a database. Furthermore, information of the capacity of a memory cell portion and the area of a peripheral circuit portion, for example, the area of a peripheral circuit portion of an SRAM included in a target product, can be estimated after determining the architecture of the SRAM, and specifically after determining the capacity, the word number, the bit number or the column number of the SRAM, on the basis of the bit number, the word number or the column number of a corresponding memory cell portion. With respect to a memory circuit such as an SRAM to be determined for a redundancy repair condition, the area is previously calculated separately whether or not the memory circuit is to be subjected to the redundancy repair. With respect to an SRAM to be examined for the fuse share, information of the capacities of the SRAMs dealt with as one SRAM in the fuse share and the area of their peripheral circuit portions is previously prepared correspondingly to each fuse share condition to be examined.

In the second yield calculation method of this invention, the information of the capacities and the areas, the critical area values per unit area or per unit capacity stored in the database and a yield model formula for, for example, an SRAM attained after the redundancy repair are used, so that a yield can be predicted before starting layout design of an actual product separately with respect to the case where a redundancy repair circuit is or is not provided in, for example, each memory circuit in a memory cell array portion and the case where a plurality of memory circuits share one fuse.

Moreover, in the second yield calculation method of this invention, with respect to a given process employed for the fabrication of the target product, the kinds of circuit elements are classified into an SRAM, a ROM (read only memory), a logic circuit, an analog circuit, an I/O region, an interconnect region and the like, and an effective critical area value per unit area or per unit capacity of each kind of circuit elements may be stored in a database. In this case, if there is another product type data whose design has already been completed, the existing data is classified into circuit elements such as a ROM, an SRAM, a logic circuit, an analog circuit, an I/O region, an interconnect region and the like, and resultant data of each circuit element is subjected to the critical area analysis through EDA (electronic design automation) processing, so as to obtain an effective critical area value per unit area or per unit capacity of each circuit element.

In the second yield calculation method of this invention, the above-described various information is used to determine conditions for examining the fuse share such as the areas of respective circuit elements included in an end product, the number of bit/word of a memory circuit (such as an SRAM) to be used, and a range of the total capacity such as 128 kb, 256 kb or 512 kb. Then, on the basis of the critical area values per unit area or per unit capacity of the respective circuit elements previously stored in the database and the actual areas or capacities (the area or capacity of each of a memory cell portion and a peripheral circuit portion), areas of the product corresponding to respective fuse share conditions attained in consideration of the number and the area of fuses necessary for the redundancy repair and the area increase caused by a test circuit used for the redundancy repair can be calculated. Moreover, when yields of the product corresponding to the respective fuse share conditions are calculated by using information of planned D0 values (such as D0 target values of each process to be attained in the mass production), a fuse share condition for maximizing the number of good products obtained per wafer (namely, a fuse share condition for maximizing the yield per unit area) at a peak stage of the mass production (at a stage for producing the maximum number of products) can be determined on starting the design of the product type or before completing the design data for the product type. Furthermore, the aforementioned method for determining a fuse share condition and the planned D0 values may be used to calculate a yield attained for a given period of time (for example, several years) from the start of the mass production, so as to use the calculated yield for examining profitability and determining mass production schedule or the like.

In this manner, according to the present invention, yield prediction can be appropriately performed in the case where a fuse used for the redundancy repair of a memory cell is shared by a plurality of memory circuits. Also, even in the case where a fuse share condition is arbitrarily set before starting the layout design of a product, chip sizes and yields can be predicted correspondingly to respective conditions, and a fuse share condition for maximizing the number of good chips obtained per wafer can be determined.

Specifically, according to the present invention, a yield of a device in which one fuse is shared by a plurality of memory circuits to be subjected to redundancy repair can be calculated, and a yield can be predicted before starting layout design, so that the predicted yield can be used for determining a redundancy repair condition, a fuse share condition, a project schedule or the like. Thus, the present invention is very useful.

### BRIEF DESCRIPTION OF THE DRAWINGS

FIG. 1 is a diagram for explaining a characteristic of a yield calculation method according to the invention;

FIG. 2 is a flowchart of a yield calculation method according to Embodiment 1 of the invention;

FIG. 3 is a diagram for showing an exemplified architecture of a system used for practicing a yield calculation method according to Embodiment 1 or 2 of the invention;

FIG. 4 is a flowchart of the yield calculation method according to Embodiment 2 of the invention;

FIG. 5 is a diagram for showing exemplified yields of a target product obtained, before fuse share, by the yield calculation method of Embodiment 2 of the invention;

FIG. 6 is a diagram for showing exemplified yields of a target product obtained, after the fuse share, by the yield calculation method of Embodiment 2 of the invention; and

FIG. 7 is a diagram for showing yields calculated correspondingly to respective redundancy repair conditions/fuse share conditions by the yield calculation method of Embodiment 2 of the invention.

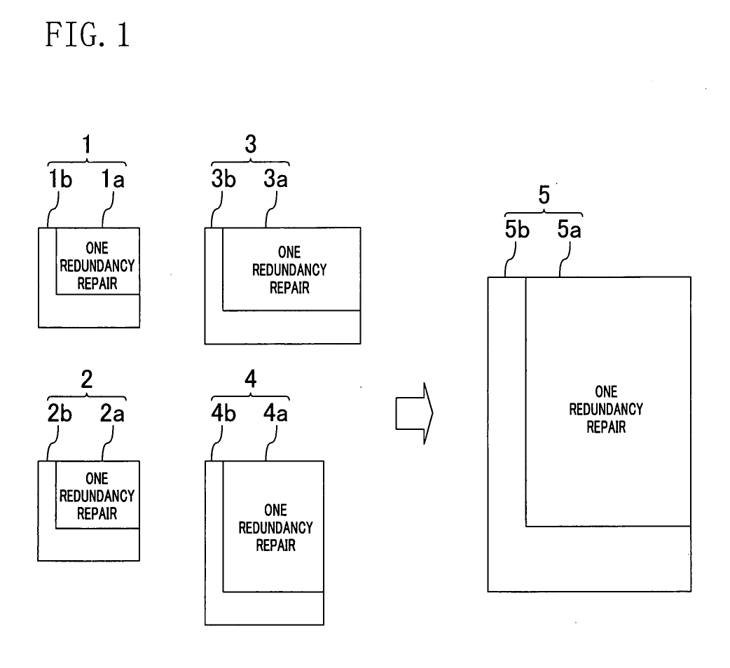

### DETAILED DESCRIPTION OF THE INVENTION

### Embodiment 1

A yield calculation method according to Embodiment 1 of the invention, and specifically, a method for calculating a yield, attained after redundancy repair, of a device including a plurality of SRAMs sharing an electric fuse, will now be described with reference to the accompanying drawings.

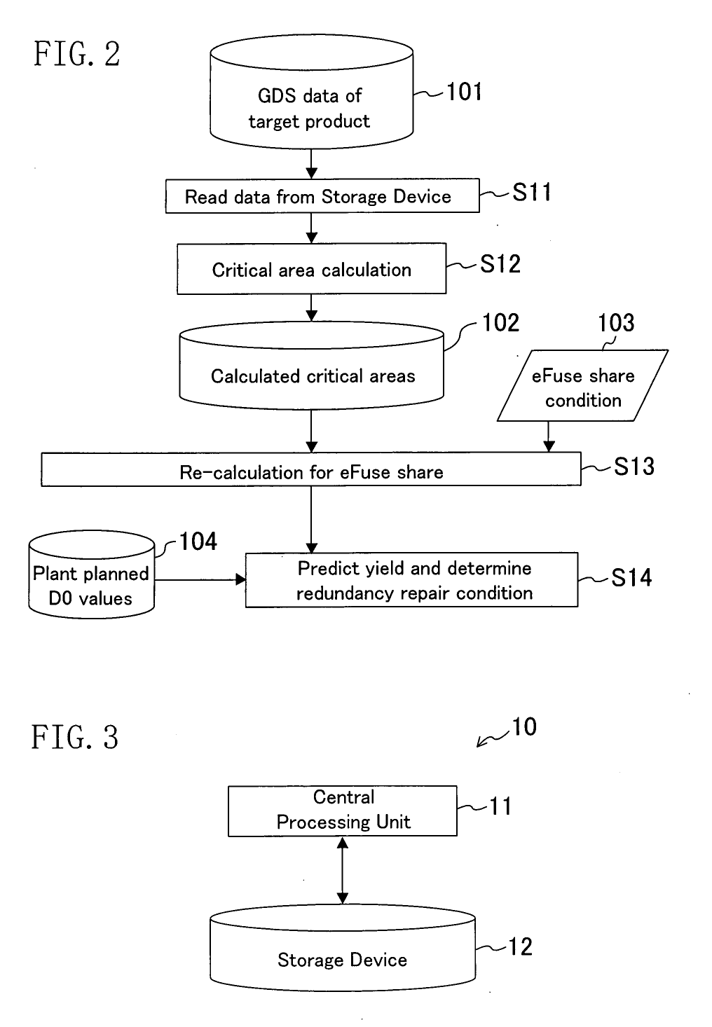

FIG. 2 is a flowchart employed in this embodiment, and FIG. 3 is a diagram for showing an exemplified architecture of a system used for practicing the process flow shown in FIG. 2. As shown in FIG. 3, the system 10 of this embodiment includes a central processing unit (CPU) 11 and a storage device 12 for storing various data described below. The CPU 11 works as computing means for reading the various data from the storage device 12 and executing respective processing (such as steps S11 through S14) of this embodiment described below by using the read data. Also, the CPU 11 works as outputting means for outputting calculation results obtained by executing the processing of this embodiment to the storage device 12. It is noted that a program to be executed on the CPU 11 for performing the processing of this embodiment described below may be recorded in a recording medium.

Now, the yield calculation method of this embodiment shown in FIG. 2 will be described in detail.

First, actual GDSII format data (layout data) 101 of a product type to be predicted for a yield is prepared to be stored in the storage device 12.

Next, in step S11, the layout data 101 is read from the storage device 12 as design data.

Then, in step S12, the design data read in step S11 is used for performing critical area analysis separately on a memory cell portion and a peripheral circuit portion of each macro cell with respect to an SRAM to be subjected to redundancy repair. It is assumed that the SRAM to be subjected to the redundancy repair includes, in addition to the memory cell portion and the peripheral circuit portion, a redundancy repair circuit portion for repairing a failure caused in the memory cell portion. Furthermore, an SRAM not to be subjected to the redundancy repair, a ROM, a logic circuit, an analog circuit, an I/O region, an interconnect region and the like may be subjected to the critical area analysis as one data with respect to each circuit element or after classifying into macro cells if necessary. At this point, the critical area analysis is performed by processing the actual layout data by using any of conventionally widely used Monte Carlo method and geometry method and an improved method of such a conventional method.

In step S12 of this embodiment, after obtaining effective critical area values of all layers related to yield calculation of the target product as described above, effective critical area values of the SRAM to be subjected to the redundancy repair calculated correspondingly to the peripheral circuit portion and the memory cell portion with respect to each macro cell are stored in a database 102 on the storage device 12 dividedly from effective critical area values of the SRAM not to be subjected to the redundancy repair and the other circuit elements.

Next, in step S13, an electric fuse (eFuse) share condition 103 is input, and in accordance with the contents of this input, all SRAMs sharing one fuse are replaced with a single SRAM having a capacity equal to the total capacity of the SRAMs, and effective critical area values are calculated again. Specifically, respective total critical area values of the memory cell portions and the peripheral circuit portions of the SRAMs sharing one fuse are regarded as critical area values of a memory cell portion and a peripheral circuit portion of a virtual single SRAM. Also, in the case where there are a plurality of SRAM groups sharing fuses, the procedure of step S13 is performed on each SRAM group. The results of re-calculation performed in step S13 are stored in the database 102 on the storage device 12.

Then, in step S14, the effective critical area values thus calculated in regard to respective circuit elements and respective layers of the target product, a defect density (for example, a defect density D0 to be attained in planned mass production) and a defect distribution function to be obtained on a production line of the target product previously calculated and stored in a database 104 and a yield model formula for an SRAM after the redundancy repair such as the Poisson model are used to calculate the yield of semiconductor devices of the target product.

In step S14, yields may be calculated correspondingly to various redundancy repair conditions, so that an actual redundancy repair condition for the target product can be determined on the basis of the thus obtained yields.

As described so far, according to Embodiment 1, a single SRAM having a capacity equal to the total capacity of a plurality of SRAMs sharing one fuse is assumed, and a yield attained after the redundancy repair is calculated by using critical area values of a memory cell portion and a peripheral circuit portion of the single SRAM. In this manner, a yield can be predicted appropriately in the case where a fuse used for the redundancy repair of a memory cell is shared by a plurality of SRAMs.

On the contrary, in a conventional method for calculating a yield attained after the redundancy repair, for example, one redundancy repair circuit is provided to each SRAM to be subjected to the redundancy repair regardless of a fuse share condition, and the yield attained after the redundancy repair is calculated on the assumption that the SRAMs can be independently repaired. Therefore, the yield cannot be predicted appropriately in accordance with the fuse share condition.

### Embodiment 2

Now, a yield calculation method according to Embodiment 2 of the invention, and specifically, a method for calculating a yield attained after redundancy repair of a device including a plurality of SRAMs sharing an electric fuse, and a method for determining an electric fuse share condition by using the same will be described with reference to the accompanying drawings.

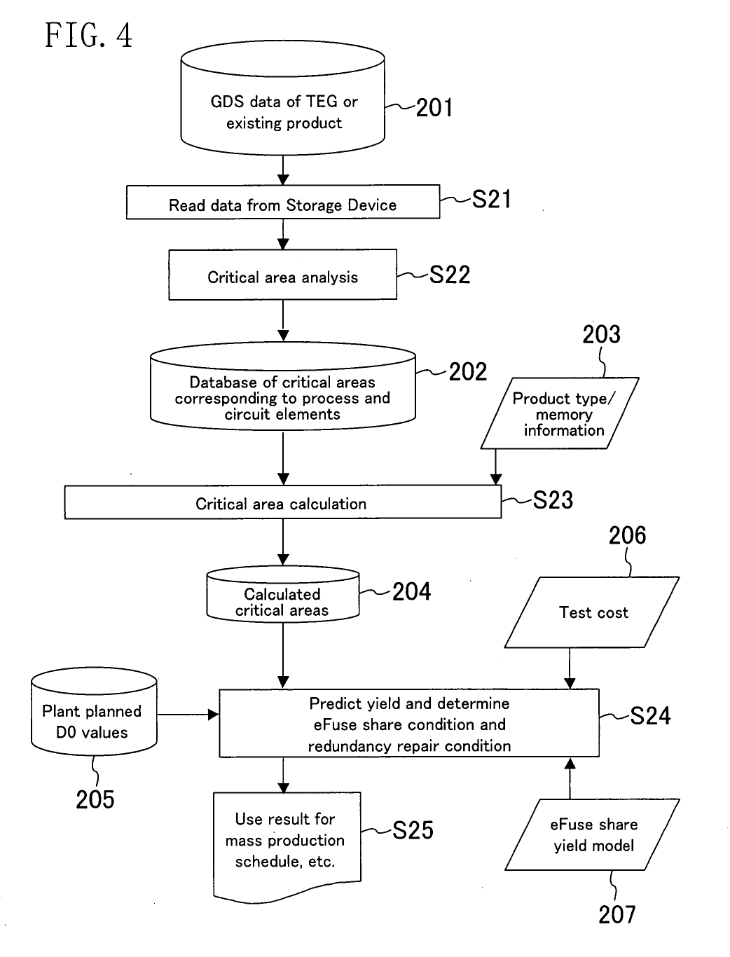

FIG. 4 is a flowchart employed in this embodiment, and FIG. 3 is a diagram for showing an exemplified architecture of a system used for practicing the process flow shown in FIG. 4. As shown in FIG. 3, the system 10 of this embodiment includes a central processing unit (CPU) 11 and a storage device 12 for storing various data described below. The CPU 11 works as computing means for reading the various data from the storage device 12 and executing respective processing (such as steps S21 through S25) of this embodiment described below by using the read data. Also, the CPU 11 works as outputting means for outputting calculation results obtained by executing the processing of this embodiment to the storage device 12. It is noted that a program to be executed on the CPU 11 for performing the processing of this embodiment described below may be recorded in a recording medium.

Now, the yield calculation method of this embodiment shown in FIG. 4 will be described in detail.

First, actual GDSII format data (layout data) 201 of, for example, development/evaluation circuit TEGs (test element groups) or other product types already designed is prepared to be stored in the storage device 12. At this point, the layout data 201 of the TEGs or the other product types as many as possible is preferably prepared.

Next, in step S21, the layout data 201 is read from the storage device 12 as design data.

Then, in step S22, the design data read in step S21 is classified into an SRAM, a ROM, a logic circuit, an analog circuit, an I/O region, an interconnect region and the like. Subsequently, design data classified into each circuit element is subjected to critical area analysis through the EDA processing. At this point, the critical area analysis is performed by processing the actual layout data by using any of conventionally widely used Monte Carlo method and geometry method and an improved method of such a conventional method.

In step S22, after obtaining effective critical area values of the respective circuit elements in all layers related to yield calculation of the target product, each effective critical area value is converted into a value per unit area or per unit capacity, and an average, a median or the like of values obtained with respect to each process (which is determined in accordance with the target product) and each circuit element is stored as a typical value in a database 202 on the storage device 12.

At this point, with respect to a memory such as an SRAM that can be redundancy repaired, an effective critical area value is previously calculated separately with respect to each unit of the redundancy repair (for example, of each macro cell) correspondingly to a memory cell portion and a peripheral circuit portion. As the effective critical area value of a memory cell portion, an effective critical area value per unit capacity is preferably calculated, and as the effective critical area value of a peripheral circuit portion, an effective critical area value per unit area is preferably calculated. Furthermore, it is assumed that the memory such as an SRAM that can be redundancy repaired includes, in addition to the memory cell portion and the peripheral circuit portion, a redundancy repair circuit portion used for repairing a failure caused in the memory cell portion.

Next, in this embodiment, before starting the design of the product type (target product), the area or the capacity of each kind of circuit elements is estimated, so as to store the estimation in the storage device 12 as product type/memory information 203. At this point, with respect to the memory such as an SRAM that can be redundancy repaired, the area or the capacity is estimated with respect to each unit of the redundancy repair (for example, of each macro cell) correspondingly to a memory cell portion and a peripheral circuit portion. Furthermore, information of the capacity and the area of a memory cell portion and a peripheral circuit portion, such as the area of a peripheral circuit portion of an SRAM included in the target product, can be estimated after determining the architecture of the SRAM, and specifically after determining the capacity, the word number, the bit number or the column number of the SRAM, on the basis of the bit number, the word number or the column number of a corresponding memory cell portion. With respect to memory circuits such as SRAMs to be determined in the redundancy repair condition, the areas are previously calculated correspondingly to whether or not the memory circuits are to be subjected to the redundancy repair. With respect to SRAMs to be examined for the fuse share, information of the capacities of SRAMs dealt with as one SRAM in the fuse share and the areas of their peripheral circuit portions is previously prepared correspondingly to respective fuse share conditions to be examined.

Next, in step S23, the product type/memory information 203, namely, the area or the capacity of each circuit element of the target product, and the effective critical area values (corresponding to the process employed for the target product) per unit area or per unit capacity of each circuit element stored in the database 202 are used for calculating effective critical area values of the target product (specifically, an actual product type of a semiconductor device to be designed) correspondingly to each circuit element and each layer, and the calculated effective critical area values are stored in a database 204 on the storage device 12.

At this point, with respect to each of an SRAM provided with a redundancy repair circuit and SRAMs sharing an electric fuse with other SRAMs, effective critical area values are calculated with respect to each macro cell at least correspondingly to a memory cell portion and a peripheral circuit portion in step S23. Also, in the same manner as in Embodiment 1, in accordance with an electric fuse share condition, total critical area values of memory cell portions and peripheral circuit portions of SRAMs together sharing one fuse are regarded as critical area values of a memory cell portion and a peripheral circuit portion of a virtual single SRAM.

Then, in step S24, the effective critical area values of the respective circuit elements and the respective layers of the target product stored in the database 204, a defect density (for example, a defect density to be attained in planned mass production) and a defect distribution function to be obtained on a production line of the target product previously calculated to be stored in a database 205, and a yield model formula such as the Poisson model (specifically, a model formula of an eFuse share yield model 207 in which plural SRMAs sharing one fuse is replaced with a single SRAM as described above) are used to calculate the yield of semiconductor devices of the target product.

Furthermore, in this embodiment, a list of planned defect densities (D0 values) of respective plants and respective processes may be stored in the database 205 on the storage device 12, and information 206 of a test cost, the number of chips obtained from one wafer (hereinafter referred to as the obtained chip number) or chip cost (obtained by dividing a cost per wafer by the obtained chip number) of the product type (target product) may be previously obtained to be stored in the storage device 12. In this manner, in step S24, the yield of the target product attained at the beginning of the production or at another desired stage may be obtained correspondingly to each memory cell redundancy repair condition and/or each electric fuse share condition by using the effective critical area values of the respective circuit elements and the respective layers of the target product stored in the database 204, planned D0 values of a production projected plant for the target product selected from the list of the planned defect densities (D0 values) of the respective plants and processes (namely, the contents of the database 205), and the information 206 of the test cost or the like. In this case, electric fuse share conditions may include a case where each SRAM to be redundancy repaired is provided with, for example, one electric fuse. Also, not only the yield but also a total area of fuses to be provided may be obtained correspondingly to each electric fuse share condition.

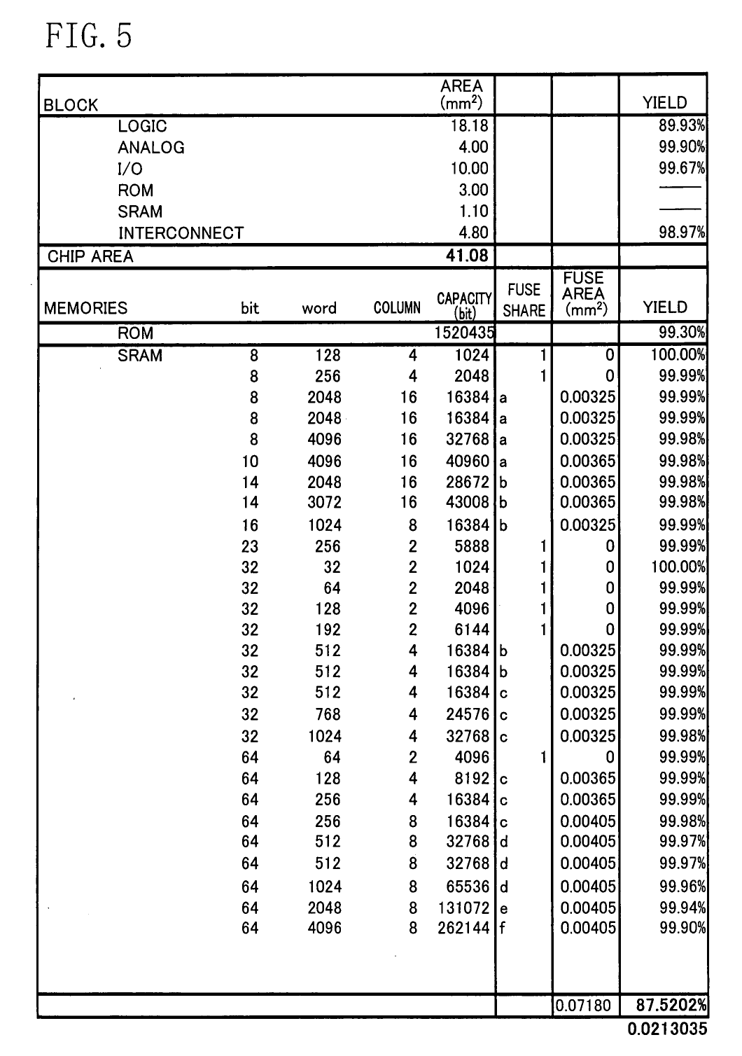

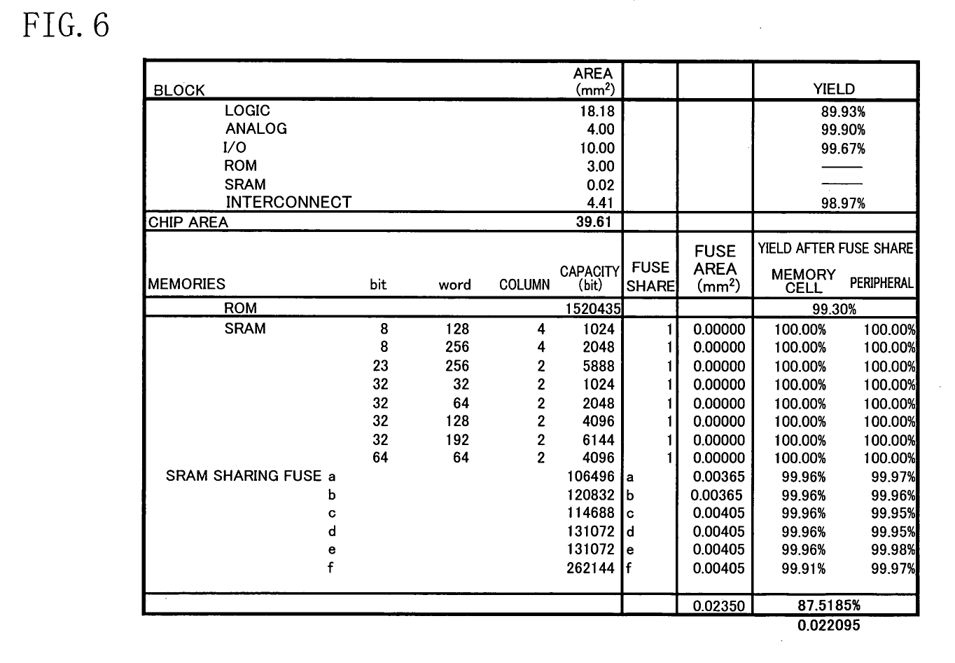

FIG. 5 shows exemplified yields of the target product obtained by the yield calculation method of this embodiment before the fuse share, and FIG. 6 shows exemplified yields of the target product obtained by the yield calculation method of this embodiment after the fuse share. It is noted that each of FIGS. 5 and 6 lists areas and yields of respective circuit elements (blocks) as well as the chip area (the size of the target product). In this case, the yield of the target product (that is, a value listed on the right-hand side in the lowermost row) is equal to a product of yields of all the circuit elements. Also, each of values “0.0213035” (of FIG. 5) and “0.022095” (of FIG. 6) respectively listed below the yields is obtained by dividing the corresponding yield by the chip area (namely, 0.0213035=0.875202÷41.08 and 0.022095=0.875185÷39.61). Furthermore, in each of FIGS. 5 and 6, the capacity is listed correspondingly to each kind of memories, and with respect to SRAMs in particular, the bit number, the word number, the column number, whether or not to share a fuse and whether or not to be subjected to the redundancy repair (Note: “1” listed in the item “fuse share” means that the corresponding SRAM is not subjected to the redundancy repair and each of “a” through “f” indicates a group of SRAMs sharing one fuse to which the corresponding SRAM belongs) are listed. Moreover, in each of FIGS. 5 and 6, fuse areas necessary for SRAMs to be redundancy repaired are shown, and a total fuse area obtained as a sum of the fuse areas is listed (as a value on the left-hand side in the lowermost row). Also, in FIG. 6, the yield of each SRAM is listed correspondingly to a memory cell portion and a peripheral circuit portion.

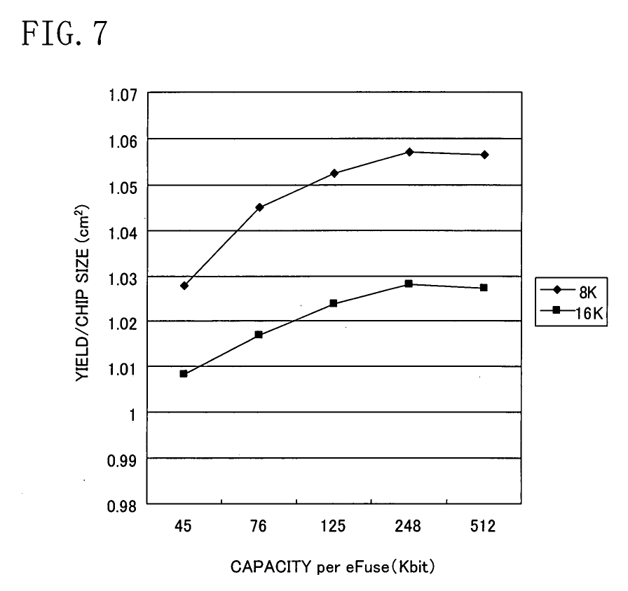

FIG. 7 shows yields calculated correspondingly to respective redundancy repair conditions and fuse share conditions by the yield calculation method of this embodiment. Specifically, FIG. 7 shows the relationship between a yield per unit area (=yield/chip size) and the capacity per electric fuse (eFuse) obtained when SRAMs of 8 kb or more or 16 kb or more share a fuse under various conditions.

In step S24 of this embodiment, when the yields of the target product obtained correspondingly to the respective redundancy repair conditions and the respective fuse share conditions in the aforementioned manner are quantitatively and numerically evaluated together with “test time cost derived from the addition of the redundancy repair process”, “cost for performing the redundancy repair”, “influence on the chip area or the obtained chip number caused by providing a redundancy repair circuit to the target product” and “influence on the chip area or the obtained chip number caused by the fuse share” all included in the information 206 of the test cost and the like, the most advantageous redundancy repair condition (for example, an SRAM that can be actually redundancy repaired) and the most advantageous electric fuse share condition can be determined. In this case, in determining an electric fuse share condition, the yields of the target product and the sizes (namely, chip sizes) of the target product are calculated under various fuse share conditions, and the calculated yields of the target product are divided respectively by the calculated chip sizes, so as to calculate the yields per unit area of the target product corresponding to the respective fuse share conditions. Then, the condition for attaining the maximum yield per unit area of the target product among the calculated yields may be selected as the most advantageous electric fuse share condition.

Next, in step S25, the redundancy repair condition and the fuse share condition determined in step S24, the effective critical area values of the respective circuit elements and the respective layers of the target product stored in the database 204, and the planned D0 values of the production projected plant for the target product (for example, D0 target values of respective processing in the mass production) stored in the database 205 are used to calculate a yield attained for a given period of time (for example, several years) from the start of the mass production, and on the basis of the thus calculated yield, the profitability is examined and the mass production schedule is determined.

As described so far, according to Embodiment 2, the following effects can be attained in addition to the same effects as those attained in Embodiment 1: A critical area value, which is a parameter necessary for calculating a yield of a given semiconductor device product, can be estimated before starting actual design. Also, the critical area value can be used for accurately predicting, before starting the design of an actual semiconductor device product, the yield of the target product attained at a desired stage (for example, at a stage of mass production).

Specifically, according to Embodiment 2, yields can be predicted before starting layout design of an actual product correspondingly to the case where redundancy repair is or is not provided for, for example, each macro cell of a memory cell portion of an SRAM and the case where a plurality of SRAMs share a fuse.

In each of Embodiments 1 and 2, a fuse is shared by and the redundancy repair is performed on SRAMs, which does not limit the invention. It goes without saying that a fuse may be shared by and the redundancy repair is performed on another kind of memory circuits. Moreover, it goes without saying that a fuse used for the redundancy repair is not limited to an electric fuse.

What is claimed is:

1. A yield calculation method for calculating a yield of a device including a plurality of memory circuits,
wherein in a case where a fuse used for redundancy repair is shared by at least two or more memory circuits out of said plurality of memory circuits, said two or more memory circuits sharing said fuse are replaced with one memory circuit having a capacity equal to a total capacity of said two or more memory circuits for calculating said yield of said device.

2. The yield calculation method of claim 1,
wherein various fuse share conditions are used for calculating a yield and a size of said device corresponding to each of said various fuse share conditions, and a yield per unit area of said device corresponding to each of said various fuse share conditions is calculated by dividing said calculated yield of said device by said calculated size of said device, and
one of said various fuse share conditions for maximizing said calculated yield per unit area of said device is selected as a fuse share condition for said device.

3. The yield calculation method of claim 1,
wherein each of said plurality of memory circuits includes a memory cell portion, a peripheral circuit portion and a redundancy repair circuit portion used for repairing a failure caused in said memory cell portion, and
various fuse share conditions including a condition where a fuse used for the redundancy repair is provided to each of said plurality of memory circuits are used for calculating a yield of said device and a fuse total area corresponding to each of said fuse share conditions.

4. The yield calculation method of claim 3,
wherein an effective critical area value of each of said plurality of memory circuits is calculated correspondingly to at least said memory cell portion and said peripheral circuit portion for calculating a yield of said device corresponding to each of various fuse share conditions by using said calculated effective critical area value, and
in calculating said yield of said device, a sum of effective critical area values of said memory cell portions of said at least two or more memory circuits sharing said fuse and a sum of effective area values of said peripheral circuit portions of said at least two or more memory circuits sharing said fuse are calculated, and said at least two or more memory circuits sharing said fuse are replaced with one memory circuit including a memory cell portion corresponding to said calculated sum of said effective critical area values of said memory cell portions and a peripheral circuit portion corresponding to said calculated sum of said effective critical area values of said peripheral circuit portions.

5. The yield calculation method of claim 4,
wherein said effective critical area values of said memory cell portions and said peripheral circuit portions are calculated on the basis of effective critical area values per unit area or per unit capacity previously calculated in regard to respective circuit elements and areas or capacities of said memory cell portions and said peripheral circuit portions.

6. The yield calculation method of claim 5,
wherein said effective critical area values per unit area or per unit capacity calculated in regard to the respective circuit elements are obtained through critical area analysis of a circuit TEG or another product and stored in a database.

7. The yield calculation method of claim 4,
wherein said yield of said device corresponding to each of said various fuse share conditions is calculated by using a planned defect density attained in mass production of said device, and a fuse share condition for said device is determined in consideration of said calculated yield of said device corresponding to each of said various fuse share conditions and influence of fuse share on a size of said device or on an obtained chip number.

8. The yield calculation method of claim 7,
wherein said determined fuse share condition, said effective critical area values per unit area or per unit capacity previously calculated in regard to the respective circuit elements and said planned defect density are used for calculating a yield of said device attained for a given period of time from start of mass production of said device, and profitability is examined and a mass production schedule is determined on the basis of said calculated yield.

9. The yield calculation method of claim 1,
wherein said fuse is an electric fuse.
